(19) United States
(12) Patent Application Publication
(10) Pub. No.: US 2003/0152765 A1
(43) Pub. Date: Aug. 14, 2003

(54) Refrigerator shelf liner system

(76) Inventor: Cynthia L. Lewis, Saint Joseph, MI (US)

Correspondence Address: Michael S. Neustel, Suite No. 4, 2534 South University Drive, Fargo, ND, 58103, US

(21) Appl. No.: 10/076,756

(22) Filed: Feb. 13, 2002

(51) Int. Cl. D04B 1/00; D04C 1/00; D04G 1/00; D03D 9/00; D03D 19/00; D04B 21/00; B32B 7/12; B32B 15/04

(52) U.S. Cl. 428/343; 442/1

(57) ABSTRACT

A refrigerator shelf liner system for protecting the upper surfaces of refrigerator shelves. The refrigerator shelf liner system includes a rear member having a rear surface, a plurality of adhesive strips attached to the rear surface, a first arm and a second arm extending from the distal ends of the rear member, a cover attached to the rear member, and a roll of protective material rotatably retained between the arms. The adhesive strips secure the rear member to the interior wall of a refrigerator above a shelf to be protected by a sheet dispensed from the roll. The roll preferably contains a plurality of protective sheets separated by a line of perforations.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to refrigerators and more specifically it relates to a refrigerator shelf liner system for protecting the upper surfaces of refrigerator shelves.

2. Description of the Prior Art

Examples of patented devices which are related to the present invention include U.S. Pat. No. 5,046,604 to Forhetz et al.; U.S. Pat. No. 4,465,729 to Cancio et al.; U.S. Pat. No. 5,874,371 to Owen; and U.S. Pat. No. 6,245,697 to Conrad et al.

While these devices may be suitable for the particular purpose to which they address, they are not as suitable for protecting the upper surfaces of refrigerator shelves. Conventional refrigerator shelves are not designed for easy and simple cleaning.

In these respects, the refrigerator shelf liner system according to the present invention substantially departs from the conventional concepts and designs of the prior art, and in so doing provides an apparatus primarily developed for the purpose of protecting the upper surfaces of refrigerator shelves.

### SUMMARY OF THE INVENTION

In view of the foregoing disadvantages inherent in the known types of refrigerator shelves now present in the prior art, the present invention provides a new refrigerator shelf liner system construction wherein the same can be utilized for protecting the upper surfaces of refrigerator shelves.

The general purpose of the present invention, which will be described subsequently in greater detail, is to provide a new refrigerator shelf liner system that has many of the advantages of the attempted solutions mentioned heretofore and many novel features that result in a new refrigerator shelf liner system which is not anticipated, rendered obvious, suggested, or even implied by any of the prior art, either alone or in any combination thereof.

To attain this, the present invention generally comprises a rear member having a rear surface, a plurality of adhesive strips attached to the rear surface, a first arm and a second arm extending from the distal ends of the rear member, a cover attached to the rear member, and a roll of protective material rotatably retained between the arms. The adhesive strips secure the rear member to the interior wall of a refrigerator above a shelf to be protected by a sheet dispensed from the roll. The roll preferably contains a plurality of protective sheets separated by a line of perforations.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a refrigerator shelf liner system that will overcome the shortcomings of the prior art devices.

A second object is to provide a refrigerator shelf liner system for protecting the upper surfaces of refrigerator shelves.

Another object is to provide a refrigerator shelf liner system that may be utilized within various styles and sizes of refrigerators.

An additional object is to provide a refrigerator shelf liner system that may be utilized within existing conventional refrigerators.

A further object is to provide a refrigerator shelf liner system that may be utilized upon various other devices such as microwaves, freezers and similar devices.

Another object is to provide a refrigerator shelf liner system that reduces the amount of labor required to clean a refrigerator.

A further object is to provide a refrigerator shelf liner system that improves the interior appearance of a refrigerator.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention secured within a refrigerator.

FIG. 2 is a front view of the present invention secured within a refrigerator.

FIG. 3 is an upper perspective view of the present invention.

FIG. 4 is an upper perspective view of the present invention with the cover opened.

FIG. 5 is a front view of the present invention with the cover opened.

FIG. 6 is an exploded upper perspective view of the present invention.

FIG. 7 is an upper perspective view of the present invention with a sheet removed from thereof.

FIG. 8 is an upper perspective view of the present invention with a sheet partially positioned upon an upper surface of a shelf.

FIG. 9 is a rear upper perspective view illustrating the adhesive strips.

FIG. 10 is a cutaway perspective view of the sheet structure.

### DESCRIPTION OF THE PREFERRED EMBODIMENT

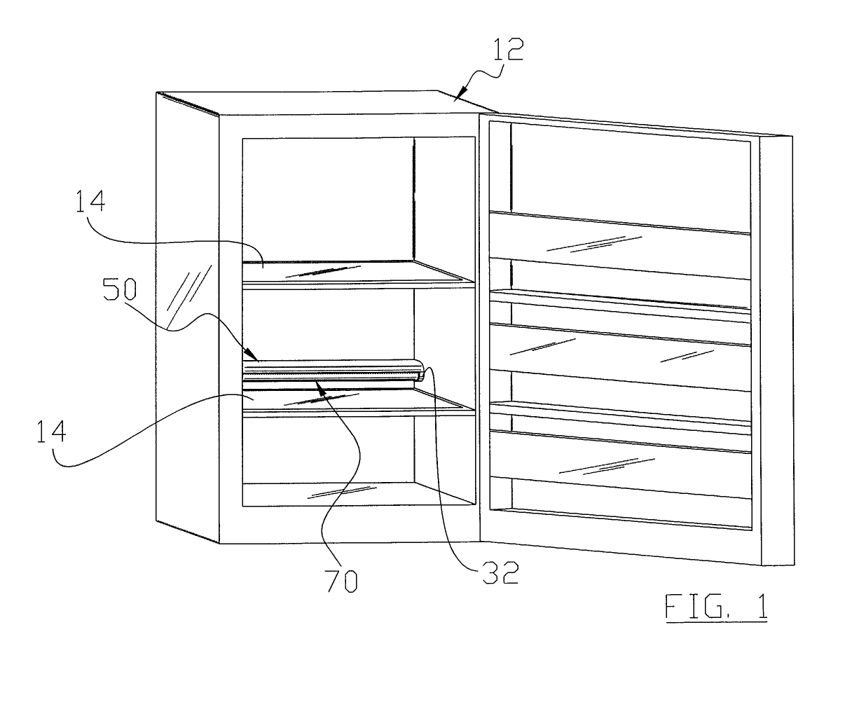

Turning now descriptively to the drawings, in which similar reference characters denote similar elements throughout the several views, FIGS. 1 through 10 illustrate a refrigerator shelf liner system 10, which comprises a rear member 20 having a rear surface 24, a plurality of adhesive strips 26 attached to the rear surface 24, a first arm 30 and a second arm 40 extending from the distal ends of the rear member 20, a cover 50 attached to the rear member 20, and a roll 70 of protective material rotatably retained between the arms. The adhesive strips 26 secure the rear member 20 to the interior wall of a refrigerator 12 above a shelf 14 to be protected by a sheet 74 dispensed from the roll 70. The roll 70 preferably contains a plurality of protective sheets 74 separated by a line of perforations 76.

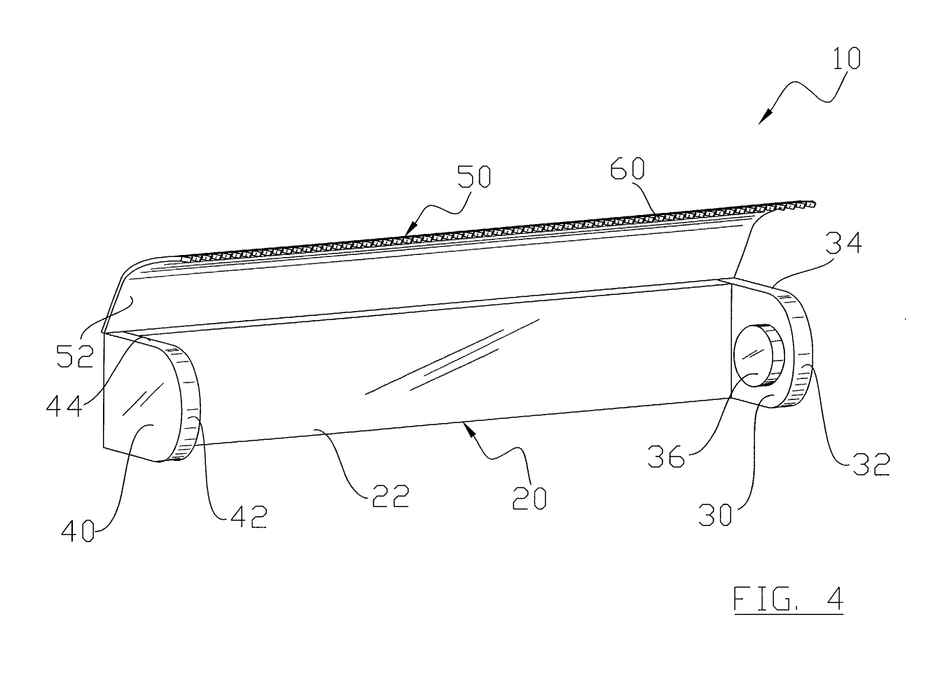

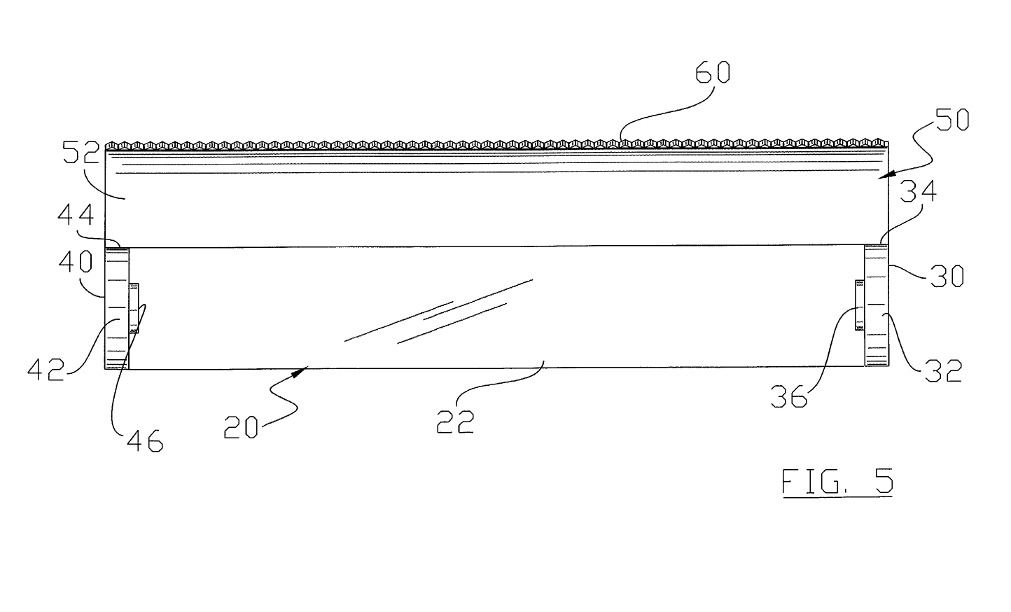

As shown in FIGS. 4 and 5 of the drawings, the rear member 20 is comprised of an elongate structure having a length approximately the width of the shelf 14 within the refrigerator 12. The rear member 20 is preferably comprised of a flat structure, however, various other structures may be utilized to construct the rear member 20. The rear member 20 has a front surface 22 and a rear surface 24. A plurality of adhesive strips 26 are attached to the rear surface 24 for securing the rear member 20 to an interior wall of the refrigerator 12. Various other securing means may be utilized to attach the rear member 20 to the interior of the refrigerator 12.

A first arm 30 and a second arm 40 are preferably attached to opposing distal ends of the rear member 20 as shown in FIGS. 4 and 5 of the drawings. The arms 30, 40 extend substantially orthogonally from the rear member 20 as best shown in FIG. 5 of the drawings. The arms 30, 40 preferably have a curved edge 32, 42 as best shown in FIG. 4 of the drawings. The arms 30, 40 further preferably include a straight upper edge 34, 44 as shown in FIG. 4 of the drawings. Various other shapes may be utilized to construct the arms 30, 40 as can be appreciated.

As shown in FIG. 5 of the drawings, a first support member 36 is attached to an inner surface of the first arm 30. The first support member 36 is preferably comprised of a circular structure positionable within the lumen 72 of the roll 70 for rotatably supporting the roll 70. The first support member 36 may have various other shapes as can be appreciated. The first support member 36 preferably has a length sufficient to prevent accidental removal of the roll 70 from between the arms 30, 40.

As shown in FIG. 5 of the drawings, a second support member 46 is attached to an inner surface of the second arm 40 in opposition and coaxially with the first support member 36. The second support member 46 is preferably comprised of a circular structure positionable within the lumen 72 of the roll 70 for rotatably supporting the roll 70. The second support member 46 may have various other shapes as can be appreciated. The second support member 46 preferably has a length sufficient to prevent accidental removal of the roll 70 from between the arms 30, 40.

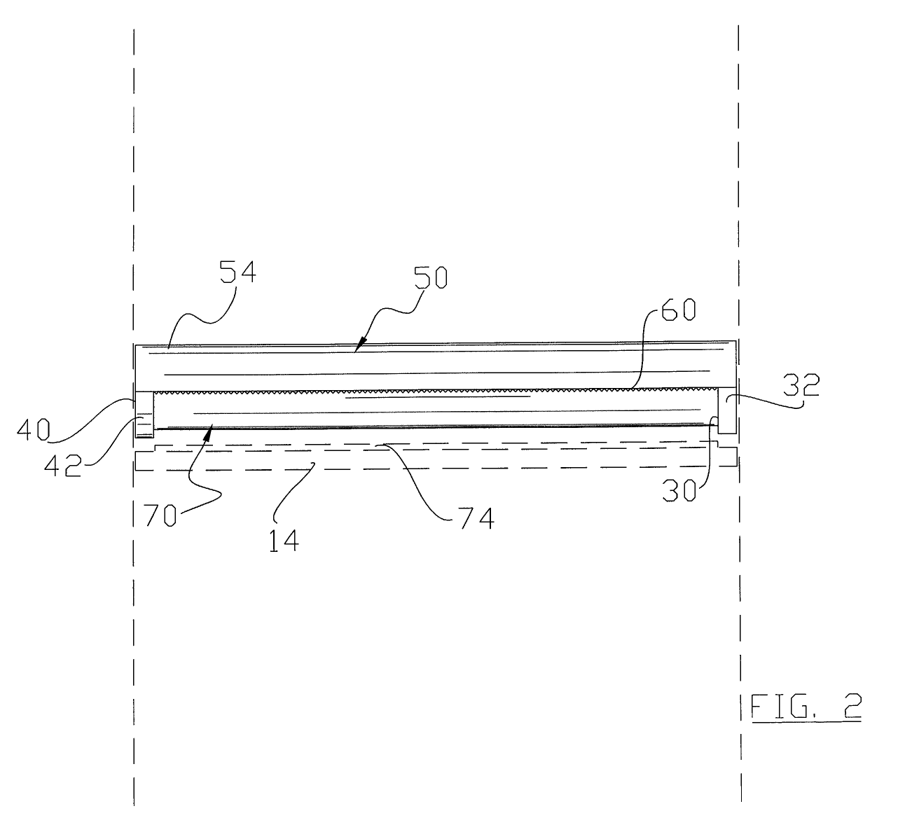

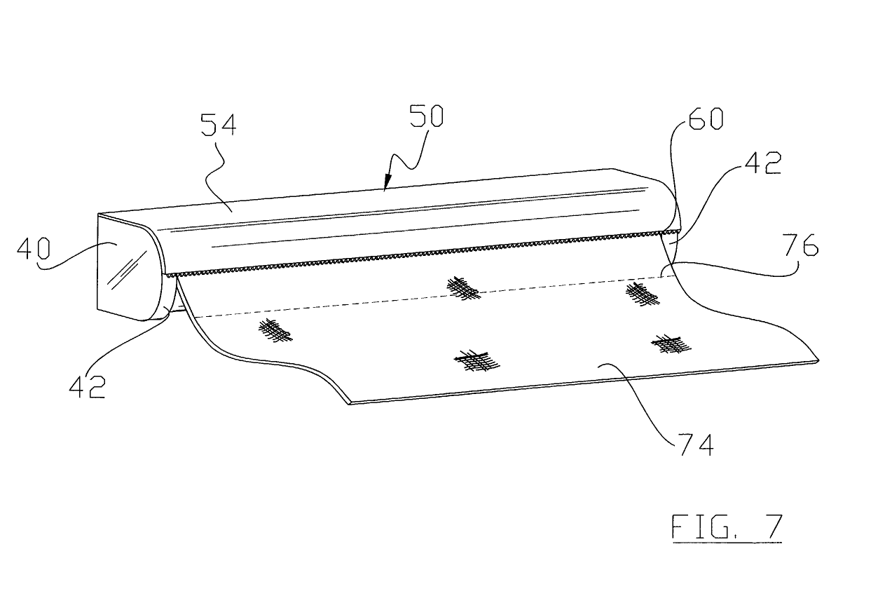

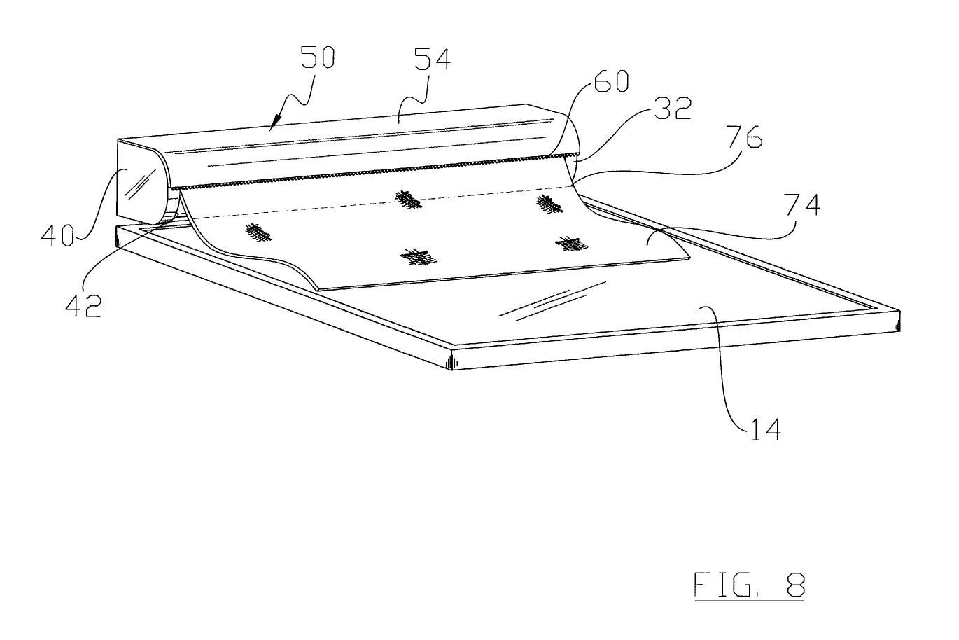

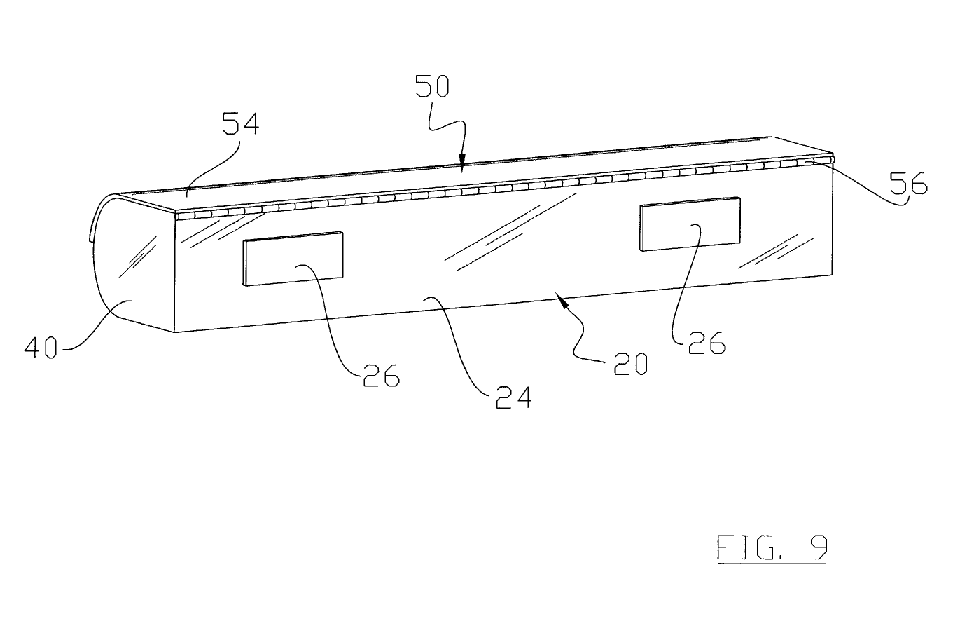

As shown in FIGS. 2 through 9 of the drawings, a cover 50 is attached to the rear member 20. The cover 50 is preferably pivotally attached to the rear member 20 by a hinge 56 as shown in FIG. 9 of the drawings. The cover 50 has a flat portion 52 that corresponds to the upper edges 34, 44 of the arms 30, 40. The cover 50 also has a curved portion 54 that corresponds to the curved edges 32, 42 of the arms 30, 40. The cover 50 may be non-movably attached to the rear member 20, however, the cover 50 being pivotally attached allows for easy removal and installation of the roll 70 between the arms 30, 40. The cover 50 preferably has a cutting edge 60 comprised of one or more blade members for cutting a sheet 74 from the roll 70. The cover 50 preferably overlaps upon the arms 30, 40 as shown in FIGS. 7 and 8 of the drawings.

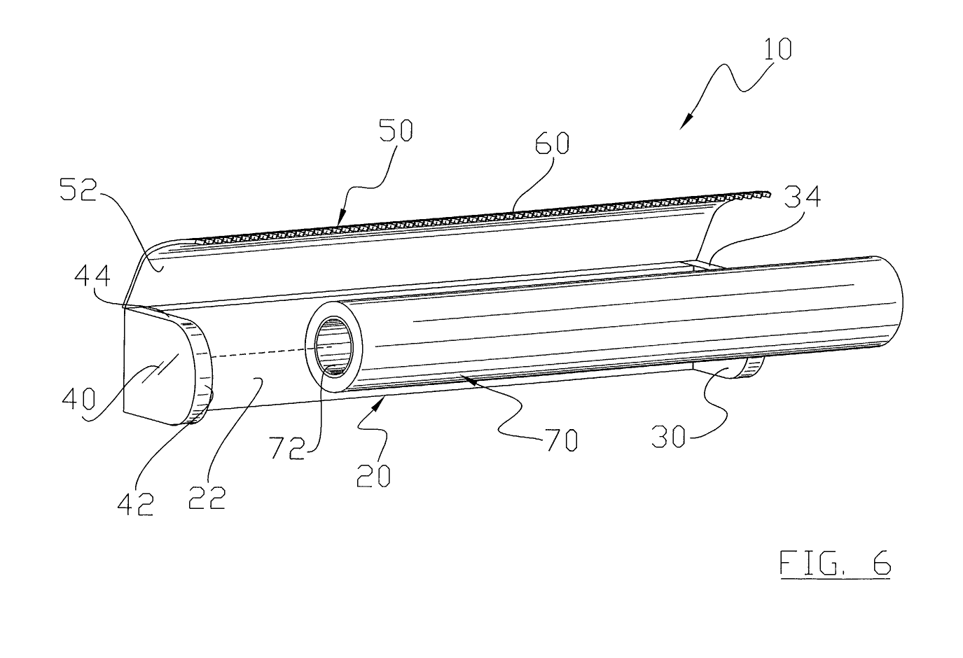

As shown in FIG. 6 of the drawings, the roll 70 is an elongate structure approximately the width of the rear member 20. The roll 70 is removably positionable between the arms 30, 40 by expanding the arms 30, 40 outwardly from one another and positioning the lumen 72 of the roll 70 upon the support members 36, 46.

The roll 70 may contain a solid sheet 74 of material that is cut into separate sheets 74 with the cutting edge 60 or the roll 70 may contain a plurality of sheets 74 separated by a plurality of perforations 76. The dispensed sheet 74 from the roll 70 preferably has a length and a width sufficient to cover 50 at least a majority of the upper surface of a shelf 14 as shown in FIG. 1 of the drawings.

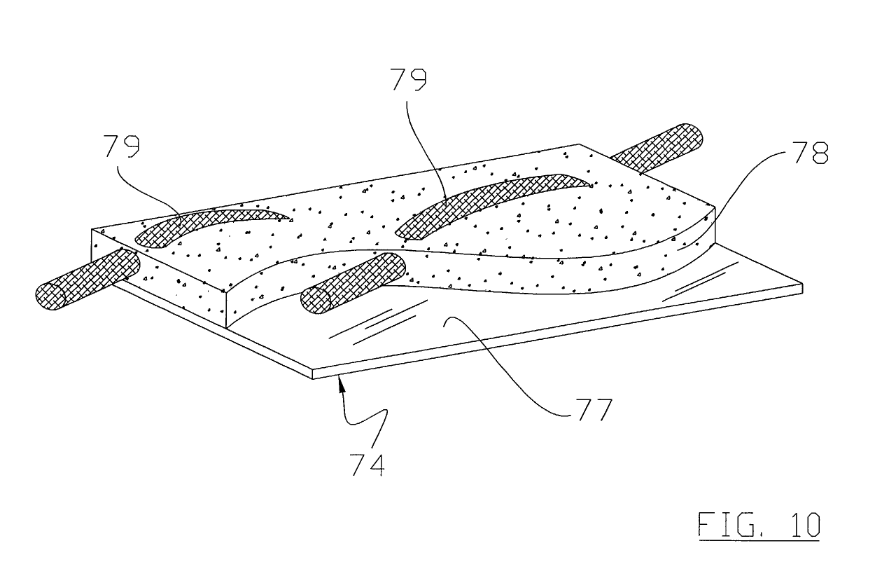

As shown in FIG. 10 of the drawings, each sheet 74 upon the roll 70 preferably has a non-permeable layer 77 on the bottom and an absorbent layer 78 secured to the non-permeable layer 77. The non-permeable layer 77 prevents fluids from passing through the sheet 74 while the absorbent layer 78 absorbs a specific volume of fluid to prevent the fluid from dispersing off the sheet 74. The non-permeable layer 77 may be comprised of various materials such as but not limited to vinyl, plastic or the like. The permeable layer may be comprised of any material capable of absorbing fluids such as but not limited to paper, cloth and the like. Each sheet 74 further preferably includes an odor absorbent material 79 such as but not limited to baking soda, charcoal and the like. Finally, each sheet 74 may have a specific desired color and design to coordinate with the refrigerator 12 and the kitchen.

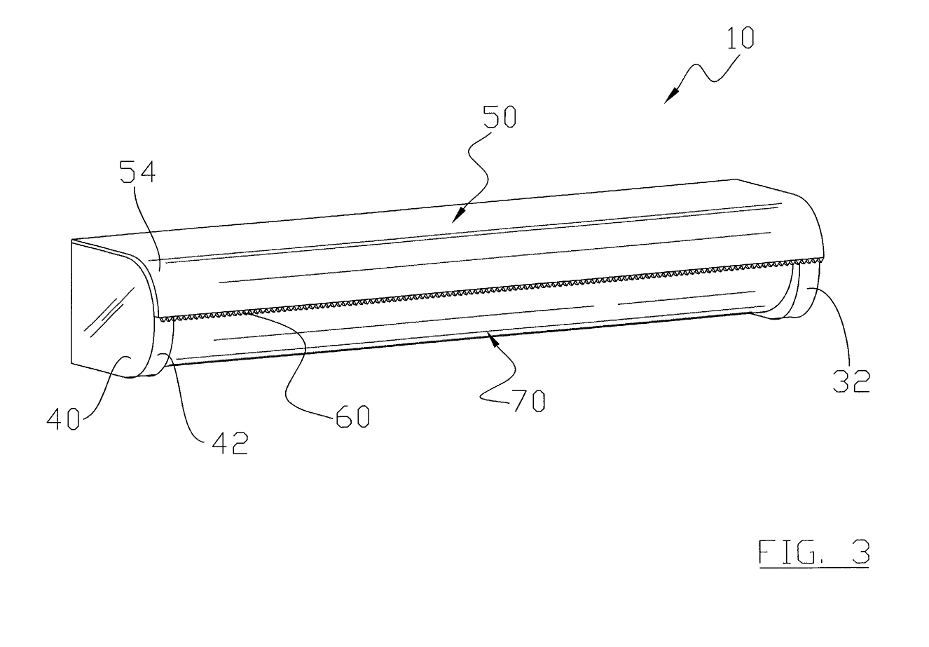

In use, the user first secures the rear member 20 to the rear interior wall above a shelf 14 within the refrigerator 12. The user then secures a roll 70 between the arms 30, 40 as shown in FIGS. 3 and 6 of the drawings. The user then pulls upon the leading sheet 74 from the roll 70 thereby causing the roll 70 to rotate upon the support members 36, 46. The user then cuts the sheet 74 to the desired length with the cutting edge 60 or by tearing along the perforations 76. The user then lays the sheet 74 upon the upper surface of the shelf 14 to protect the shelf 14 from spillage of fluids and material. The user periodically will remove and dispose of the sheet 74 followed by repeating the above steps.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Refrigerator Shelf Liner System

| □ ENVIRONMENTAL ELEMENTS | □ 40. Second Arm |
|---|---|
| □ | □ 41. |
| □ | □ 42. Second Curved Edge |
| □ | □ 43. |
| □ | □ 44. Second Upper Edge |
| □ | □ 45. |
| □ | □ 46. Second Support Member |
| □ | □ 47. |
| □ | □ 48. |
| □ | □ 49. |
| □ 10. Refrigerator Shelf Liner System | □ 50. Cover |
| □ 11. | □ 51. |
| □ 12. Refrigerator | □ 52. Flat Portion |
| □ 13. | □ 53. |
| □ 14. Shelf | □ 54. Curved Portion |
| □ 15. | □ 55. |
| □ 16. | □ 56. Hinge |
| □ 17. | □ 57. |
| □ 18. | □ 58. |
| □ 19. | □ 59. |
| □ 20. Rear Member | □ 60. Cutting Edge |
| □ 21. | □ 61. |
| □ 22. Front Surface | □ 62. |
| □ 23. | □ 63. |
| □ 24. Rear Surface | □ 64. |
| □ 25. | □ 65. |
| □ 26. Adhesive Strips | □ 66. |
| □ 27. | □ 67. |
| □ 28. | □ 68. |
| □ 29. | □ 69. |
| □ 30. First Arm | □ 70. Roll |
| □ 31. | □ 71. |
| □ 32. First Curved Edge | □ 72. Lumen |
| □ 33. | □ 73. |
| □ 34. First Upper Edge | □ 74. Sheet |
| □ 35. | □ 75. |
| □ 36. First Support Member | □ 76. Perforations |
| □ 37. | □ 77. Non-Permeable Layer |
| □ 38. | □ 78. Absorbent Layer |
| □ 39. | □ 79. Odor Absorbent Material |

I claim:

1. A refrigerator shelf liner system, comprising:
a rear member having a front surface and a rear surface;
at least one adhesive strip attached to said rear surface for securing said rear member to an interior surface of a refrigerator;
a first arm attached to a first end of said rear member;
a second arm attached to a second end of said rear member opposite of said first arm; and
a roll of sheet material rotatably and releasably retained between said first arm and said second arm.

2. The refrigerator shelf liner system of claim 1, including a cover attached to said rear member extending above said roll of sheet material.

3. The refrigerator shelf liner system of claim 2, wherein said cover is pivotally attached to said rear member.

4. The refrigerator shelf liner system of claim 3, wherein said first arm and said second arm each include a curved front edge and a straight upper edge, wherein said cover has a shape corresponding to said arms.

5. The refrigerator shelf liner system of claim 2, wherein said cover includes a cutting edge for severing a sheet from said roll of sheet material.

6. The refrigerator shelf liner system of claim 1, including a first support member and a second support member attached to the respective inner surfaces of said first arm and said second arm, wherein said roll of sheet material is rotatably supported upon said support members.

7. The refrigerator shelf liner system of claim 6, wherein said support members are comprised of a circular shape.

8. The refrigerator shelf liner system of claim 1, wherein said roll of sheet material has a plurality of perforations extending traversely within for identifying a plurality of individual sheets.

9. The refrigerator shelf liner system of claim 8, wherein said individual sheets have a size approximately equal to a shelf of a refrigerator.

10. The refrigerator shelf liner system of claim 1, wherein said roll of sheet material is comprised of a non-permeable layer and an absorbent layer attached to an upper surface of said non-permeable layer.

11. The refrigerator shelf liner system of claim 1, wherein said roll of sheet material includes an odor absorbent material.

12. The refrigerator shelf liner system of claim 11, including a cover attached to said rear member extending above said roll of sheet material.

13. The refrigerator shelf liner system of claim 12, wherein said cover is pivotally attached to said rear member.

14. The refrigerator shelf liner system of claim 13, wherein said first arm and said second arm each include a curved front edge and a straight upper edge, wherein said cover has a shape corresponding to said arms.

15. The refrigerator shelf liner system of claim 12, wherein said cover includes a cutting edge for severing a sheet from said roll of sheet material.

16. The refrigerator shelf liner system of claim 11, including a first support member and a second support member attached to the respective inner surfaces of said first arm and said second arm, wherein said roll of sheet material is rotatably supported upon said support members.

17. The refrigerator shelf liner system of claim 16, wherein said support members are comprised of a circular shape.

18. The refrigerator shelf liner system of claim 11, wherein said roll of sheet material has a plurality of perforations extending traversely within for identifying a plurality of individual sheets.

19. The refrigerator shelf liner system of claim 18, wherein said individual sheets have a size approximately equal to a shelf of a refrigerator.

20. The refrigerator shelf liner system of claim 11, wherein said roll of sheet material is comprised of a non-permeable layer and an absorbent layer attached to an upper surface of said non-permeable layer.
